(19) United States
(12) Patent Application Publication
(10) Pub. No.: US 2025/0353257 A1
(43) Pub. Date: Nov. 20, 2025

(54) ADHESION MOLD LOCKING FASTENER

(71) Applicant: Rivian IP Holdings, LLC, Irvine, CA (US)

(72) Inventors: Sharbel elKantati, Windsor (CA); Adam Richard Ballard, Corona, CA (US)

(21) Appl. No.: 19/207,147

(22) Filed: May 13, 2025

Related U.S. Application Data
(60) Provisional application No. 63/647,408, filed on May 14, 2024.

(51) Int. Cl. B29C 65/70; B29K 105/00; B29L 31/34; H01M 50/184

(52) U.S. Cl. CPC B29C 65/70; H01M 50/184; B29K 2105/0097; B29L 2031/3468

(57) ABSTRACT

Techniques are provided herein for implementing an adhesion mold locking fastener that fasten two components together while optionally sealing the interface between the two components. In an implementation, an adhesive fastener includes a first bulge feature proximate to a first component having a first escape hole and a second bulge feature proximate to a second component having a second escape hole. In some implementations, the adhesive fastener extends from the first bulge feature through the first escape hole and the second escape hole to the second bulge feature. In some implementations, the first bulge feature corresponds to a first profile of a first mold applied to an exterior of the first component and the second bulge feature corresponds to a second profile of a second mold applied to the exterior of the second component.

### CROSS-REFERENCE TO RELATED APPLICATIONS

The present application claims priority to U.S. Provisional Application No. 63/647,408, filed May 14, 2024 and entitled, ADHESION MOLD LOCKING FASTENER, the entire disclosure of which is incorporated by reference in its entirety.

### INTRODUCTION

The present disclosure relates to fasteners, and in particular to adhesion mold locking fasteners.

### SUMMARY

Fastening two components together in a way that seals the interface between the two components is cumbersome, requires multiple components, and may take an extended period of time to accomplish. Some sealed fastening techniques involve a mechanical fastener such as a screw to mechanically lock the two components together and a sealer that seals the interface between the two components. In practice, the sealer may be applied to the components and then mechanically fastened using a screw or other fastener. This requires multiple parts and tools, e.g., a sealant applicator to distribute the sealant on the components and tools to apply and tighten the mechanical fastener. In accordance with the present disclosure, an adhesive locking fastener is provided that mechanically fastens and seals two components together.

Techniques of the present disclosure can be applied to fasten two or more components together while optionally sealing the interface between the two components. In an example implementation, an adhesive fastener includes a first bulge feature proximate to a first component having a first escape hole and a second bulge feature proximate to a second component having a second escape hole. In some implementations, the adhesive fastener extends from the first bulge feature through the first escape hole and the second escape hole to the second bulge feature. In some implementations, the first bulge feature corresponds to a first profile of a first mold applied to an exterior of the first component and the second bulge feature corresponds to a second profile of a second mold applied to the exterior of the second component. In some implementations, the first bulge feature and the second bulge feature are generally oblate hemispheroidal in shape. In some implementations, the first escape hole has a first generally circular shape, and the second escape hole has a second generally circular shape. In some implementations, the first escape hole includes a first shape, and the second escape hole has a second shape similar to the first shape. In some implementations, the first escape hole has a first shape, and the second escape hole has a second shape different than the first shape.

In some implementations, the first escape hole has a first shape having a generally cross-shaped pattern, and the second escape hole has a second shape having a generally cross-shaped pattern oriented approximately 45 degrees relative to the cross-shaped pattern of the first escape hole. In some implementations, the distance between the first component and the second component is between approximately 0.25 mm and 0.75 mm. In some implementations, the adhesive fastener further includes a second adhesive bonding inner surfaces of the first component and the second component. In such implementations, the first and second bulges are proximate to respective outer surfaces of the first and second components.

In another example implementation of the present disclosure, an adhesive fastener includes a first component having a first escape hole extending through the first component and a second component having a second escape hole extending through the second component. The adhesive fastener may further include a first bulge feature proximate to the first escape hole and including an adhesive, and a second bulge feature proximate to the second escape hole and including the adhesive. In such implementations, the adhesive extends from the first bulge feature though the first escape hole and the second escape hole to the second bulge feature. In some implementations, the first escape hole is aligned with the second escape hole. In some implementations, the distance between the first component and the second component does not exceed 1 mm.

In some implementations, the first component is a first battery housing having a first flange with the first escape hole extending through the first flange. In some implementations, the second component is a second battery housing having a second flange, the second escape hole extending through the second flange. In some implementations, the first flange at least partially circumscribes a first perimeter of the first battery housing, and the second flange at least partially circumscribes a second perimeter of the second battery housing. In some implementations, a screw extends through the first escape hole and the second escape hole. In such implementation, the screw may be fully enclosed by the adhesive.

In some embodiments, techniques of the present disclosure include applying an adhesive to one or both of a first surface of a first component comprising a first escape hole and a second surface of a second component comprising a second escape hole. The first and second surfaces are brought together to cause portions of the adhesive to pass through the first and second escape holes and form first and second bulge features proximate to the respective first and second escape holes. In some implementations, the techniques of the present disclosure further include applying a first mold proximate the first escape hole to receive and shape at least some of the adhesive that passes through the first escape hole to form the first bulge feature, and applying a second mold proximate the second escape hole to receive and shape at least some of the adhesive that passes through the second escape hole to form the second bulge feature. In such implementations, the first mold and second mold may be at a temperature greater than ambient temperature when the adhesive is received and shaped.

### BRIEF DESCRIPTION OF THE DRAWINGS

The above and other objects and advantages of the disclosure will be apparent upon consideration of the following detailed description, taken in conjunction with the accompanying drawings, in which:

FIG. 1 depicts an illustrative cross-sectional diagram of an adhesion mold locking fastener, in accordance with embodiments of the disclosure;

FIG. 2 depicts an illustrative cross-sectional diagram of an adhesion mold locking fastener and corresponding molds, in accordance with embodiments of the disclosure;

FIGS. 3A-3D depict illustrative cross-sectional diagrams of an adhesion mold locking fastener, in accordance with embodiments of the disclosure;

FIG. 4 depicts an illustrative perspective view and cross-sectional diagram of an adhesion mold locking fastener, in accordance with embodiments of the disclosure;

FIG. 5 depicts illustrative cross-sectional diagrams of adhesion mold locking fasteners, in accordance with embodiments of the disclosure;

FIG. 6 depicts illustrative cross-sectional diagrams of an adhesion mold locking fastener, in accordance with embodiments of the disclosure;

FIG. 7 depicts illustrative perspective diagrams of an adhesion mold locking fastener, in accordance with embodiments of the disclosure;

FIG. 8 depicts illustrative perspective diagrams of an adhesion mold locking fastener, in accordance with embodiments of the disclosure;

FIG. 9 depicts an illustrative cross-sectional diagram of an adhesion mold locking fastener, in accordance with embodiments of the disclosure;

FIG. 10 depicts an illustrative cross-sectional diagram of an adhesion mold locking fastener, in accordance with embodiments of the disclosure;

FIG. 11 depicts an illustrative process of a system for implementing an adhesion mold locking fastener, in accordance with embodiments of the disclosure; and

FIG. 12 depicts an illustrative process of a system for implementing an adhesion mold locking fastener, in accordance with embodiments of the disclosure.

### DETAILED DESCRIPTION

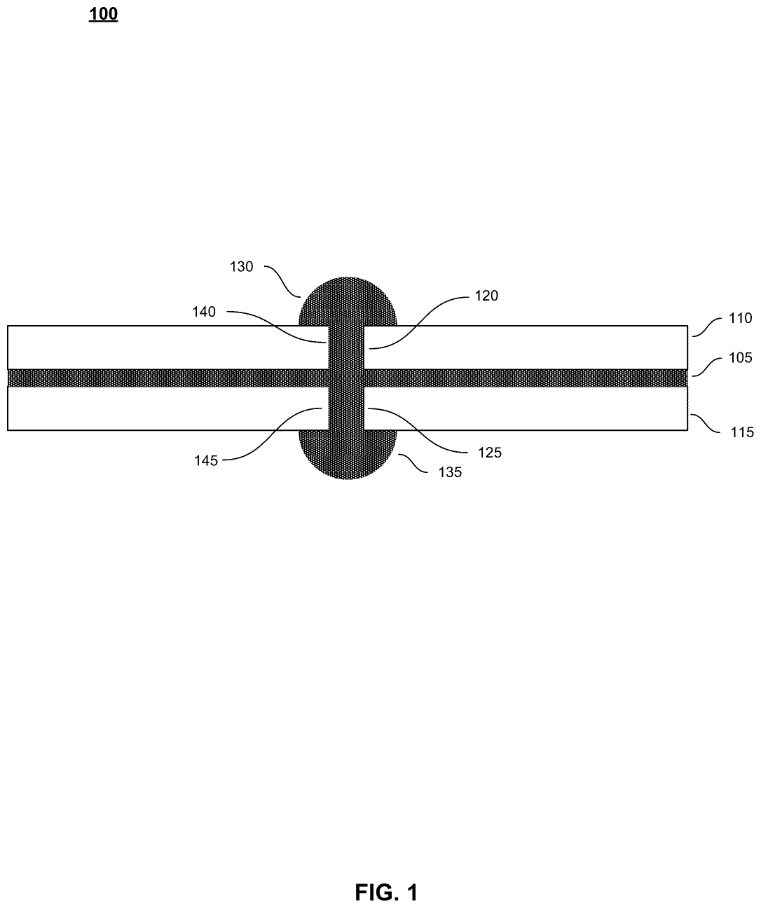

In an example embodiment of the present disclosure and with reference to FIG. 1, an adhesion mold locking fastener 100 is implemented to affix first component 110 to second component 115. The fastener includes first bulge feature 130 and second bulge feature 135 next to first component 110 and second component 115, respectively. Adhesive 105 is disbursed between first component 110 and second component 115. First component 110 includes first escape hole 120, though which the first adhesive fastener shank 140 passes. Similarly, second component 115 includes second escape hole 125, though which second adhesive fastener shank 145 passes.

Although adhesive 105 may be illustrated and described as being made from an adhesive, any suitable material or composition may be used to implement adhesive 105 without departing from the contemplated embodiments. For example, adhesive 105 may include any natural or synthetic material including non-reactive and reactive adhesives. Example non-reactive adhesives include drying adhesives (e.g., solvent-based and polymer dispersion adhesives), pressure-sensitive adhesives, contact adhesives, and hot adhesives (also referred to as hot melt adhesives). Example reactive adhesives include anaerobic adhesives, multi-part adhesives (e.g., multi-component adhesives that harden by mixing two or more components together that chemically react adhere or seal two or more components together), pre-mixed and frozen adhesives, and one-part or single-part adhesives (including ultraviolet light curing adhesives, light curing materials, heat curing adhesives, and moisture curing adhesives).

Additionally, adhesive 105 may include any sealant without departing from the contemplated embodiments. For example, adhesive 105 may include (in whole or in part) any chemically reactive, physically reactive, and/or non-reactive sealant without departing from the contemplated embodiments. Example chemically reactive sealants include silicon sealants (e.g., acetate, alkoxy, benzamide, epoxy, ester, oxime, and amine), polyurethane sealants, polysulfide sealants, and silane-modified polymer sealants (e.g., modified polyether, modified polyurethane, and modified acrylate). Example physically reactive sealants include solvent-containing adhesives (e.g., butyl, bitumen, and synthetic rubber) and water-based adhesives (e.g., acrylate dispersion and silicone emulsion). Example non-reactive sealants include sealing tapes, sealing putties, and sealing profiles. Additional sealants that may be implemented without departing from the contemplated embodiments include: acrylic resins, acrylic latexes, acoustic sealants, adhesive sealants, butyl rubber, dental sealants, elastic sealants, electronic sealants, epoxy thermosets, extruded sealants, fibrin glues, firestop barrier sealants, floor sealants, foam, grouts, hot waxes, impregnating sealants, latex sealants, metal sealants, patio sealants, paint sealants, plastic sealants, polysulfide sealants, polyurethane sealants, rubber sealants, sealcoats, seam sealants, silicone sealants, spackling pastes, stone sealers, surgical sealants, tile sealants, urethane sealants, valve sealers, varnishes, and WKTs.

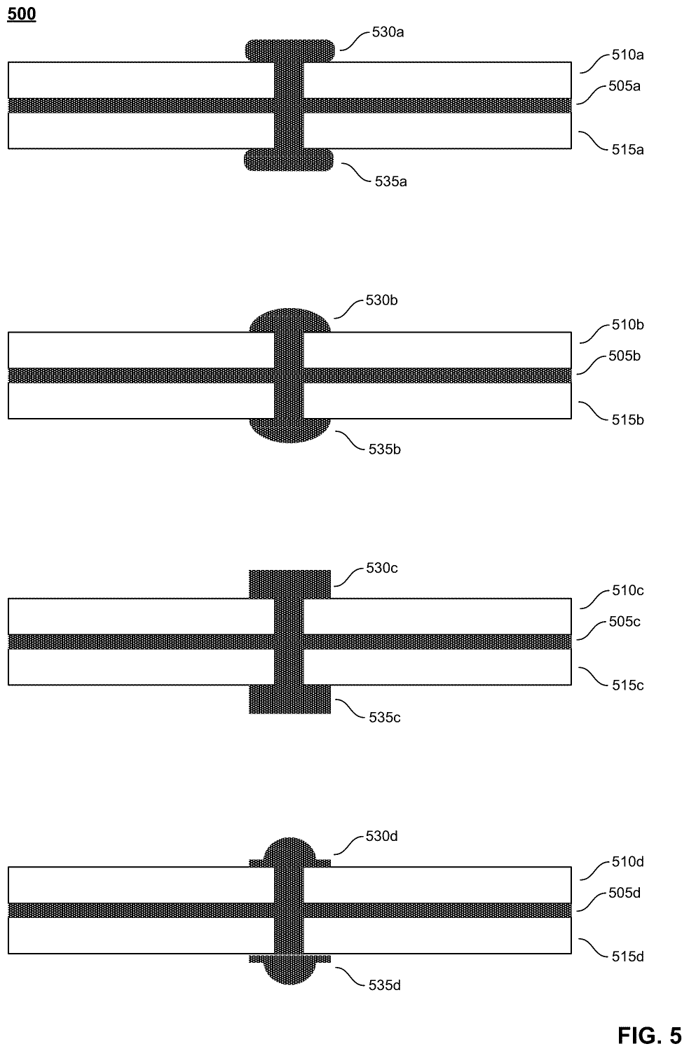

Although first bulge feature 130 and second bulge feature 135 may be illustrated and described as generally hemispherical in shape, first bulge feature 130 and second bulge feature 135 may have any size and shape without departing from the contemplated embodiments. For example, first bulge feature 130 and second bulge feature 135 may be embodied by a combination of a flat head shape and a rounded head shape. Other example head shapes that may be implemented without departing from the contemplated embodiments include a pan head, a high button head, a steeple head, a conical head, a snap head, an ellipsoid head, a brazier head, a domed head, a mushroom head, and a universal head. In addition to the various shapes, one or more of first and second bulge features 130, 135 may also be countersunk into the first or second components, and/or undercut (i.e., including an indentation or protrusion that helps prevent the fastener's removal from the escape holes and/or components). For example, 530a-530d and 535a-535d of FIG. 5 illustrate various embodiments of first bulge feature 130 and second bulge feature 135. Additionally, although first component 110 and second component 115 are illustrated and described as generally flat and straight with similar thicknesses, first component 110 and second component 115 may be embodied by any size and/or shape without departing from the contemplated embodiments. For example, in some embodiments, first component 110 and second component 115 may be flanges of a battery pack.

Additionally, the adhesion mold locking fasteners disclosed herein may further include a screw (e.g., a hex head cap screw) or bolt extending through the first and second escape holes 120, 125. In such embodiments, adhesive 105 may partially or fully enclose the screw or bolt. Further, first and/or second bulge features 130, 135 may partially or fully envelope the head of the screw or bolt, and/or a nut used to along with the screw or bolt. In such embodiments, the screw or bolt provides additionally fastening strength to the overall system.

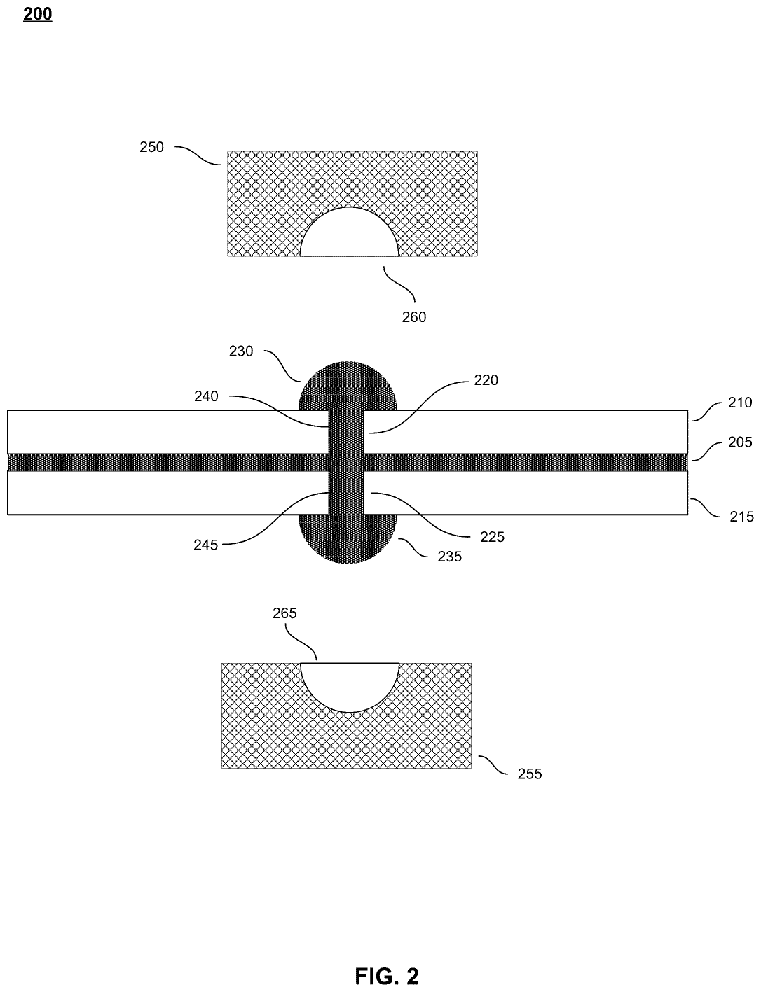

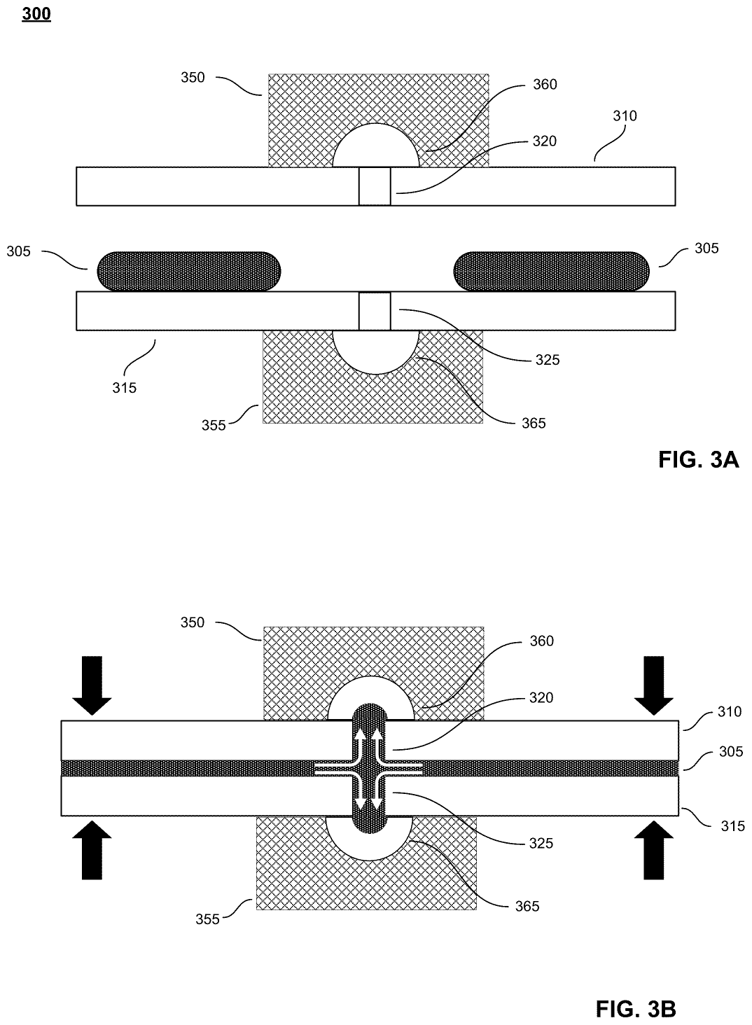

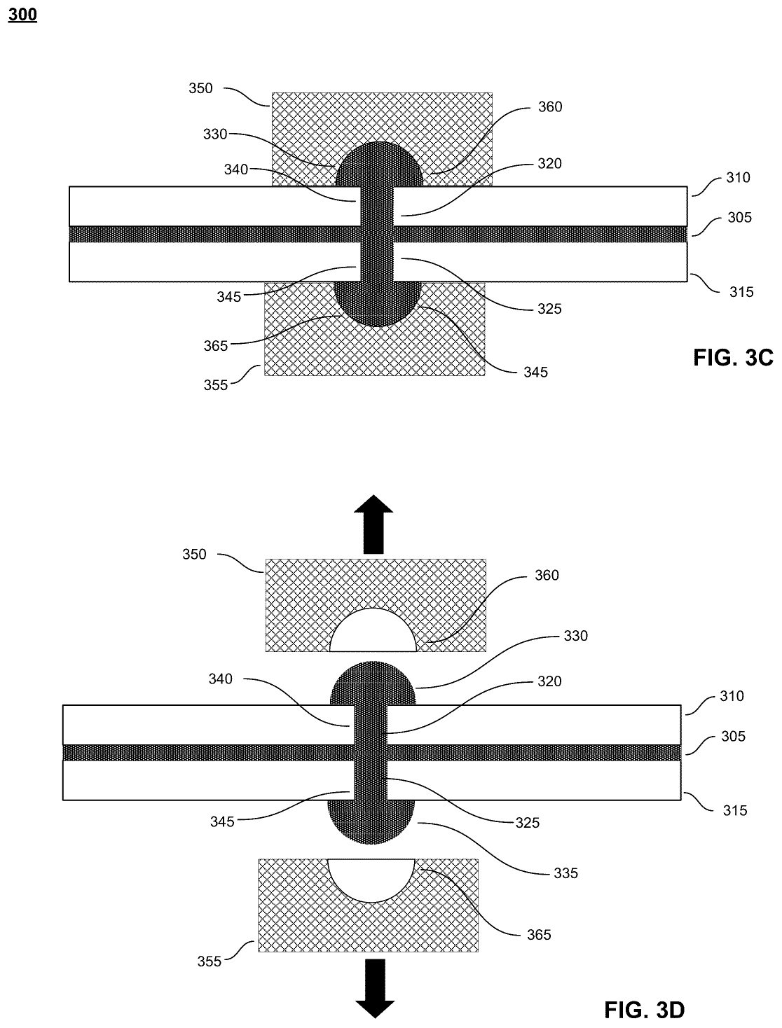

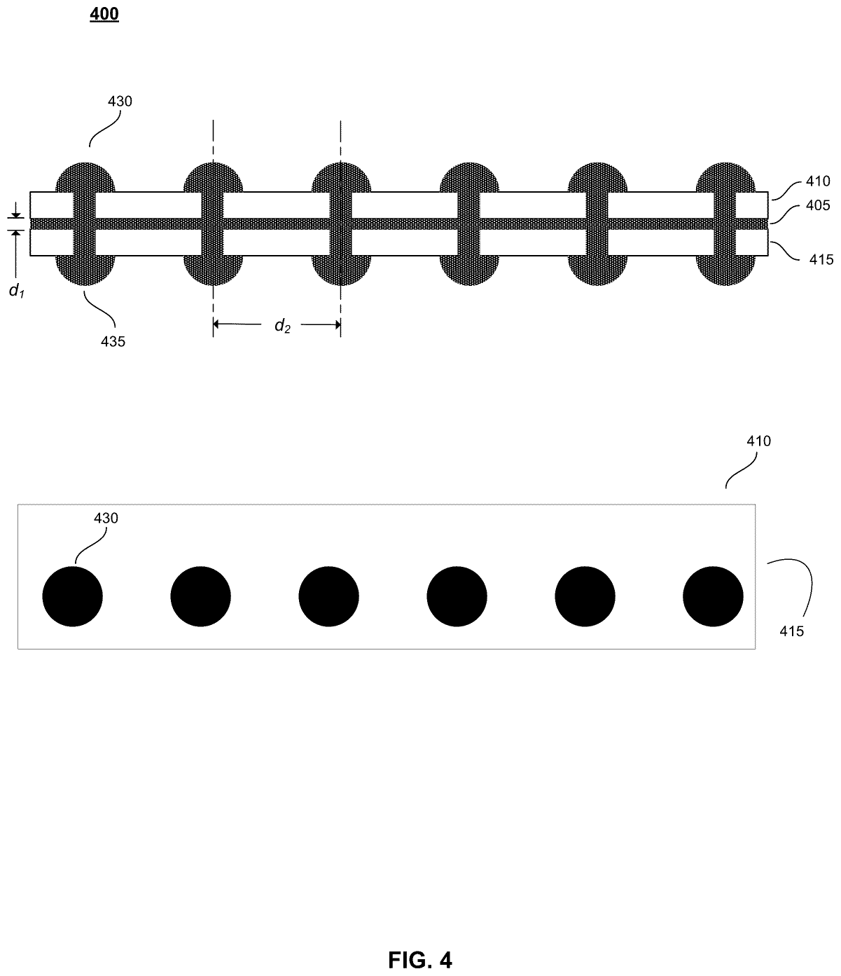

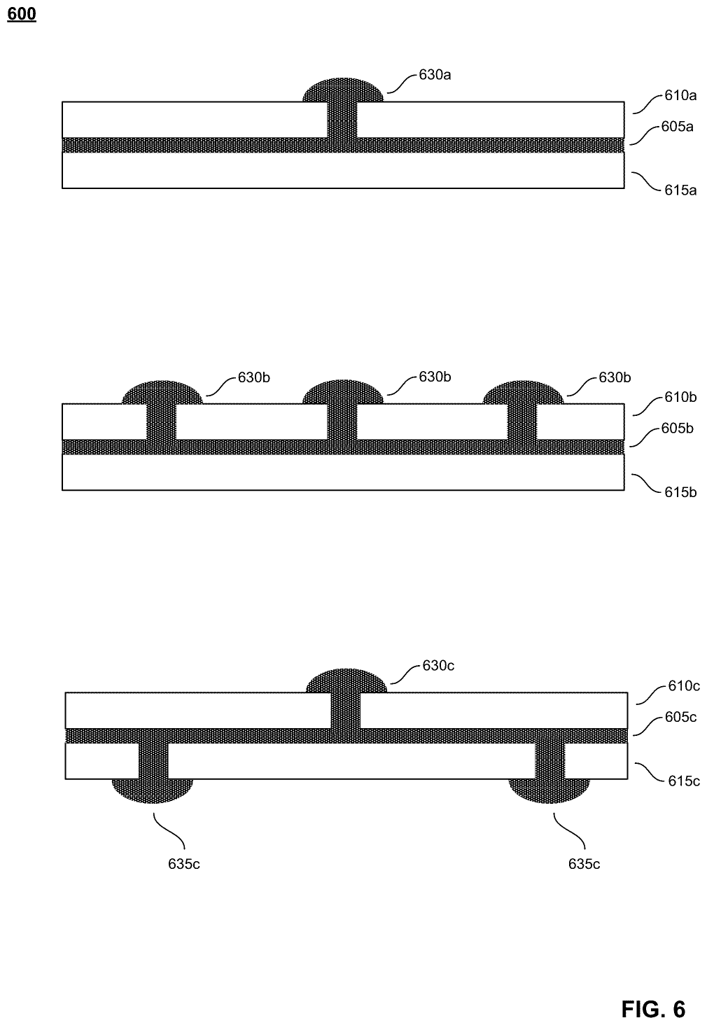

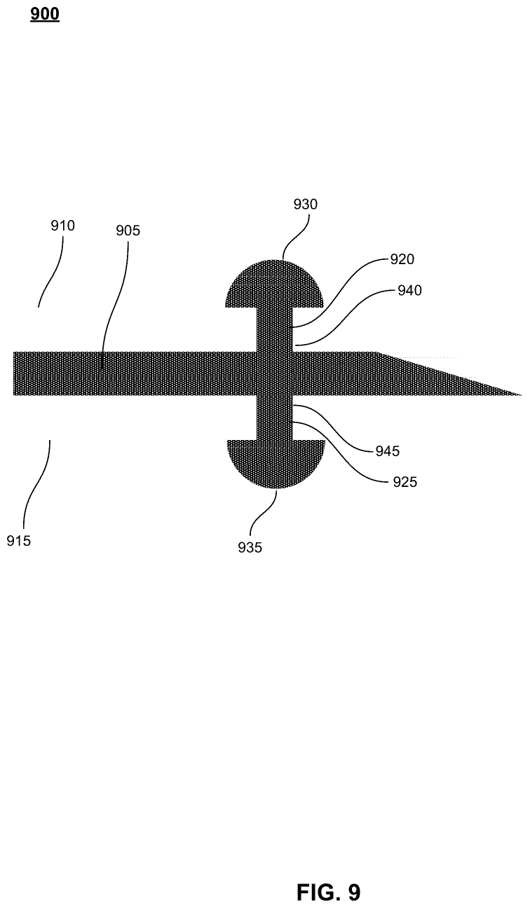

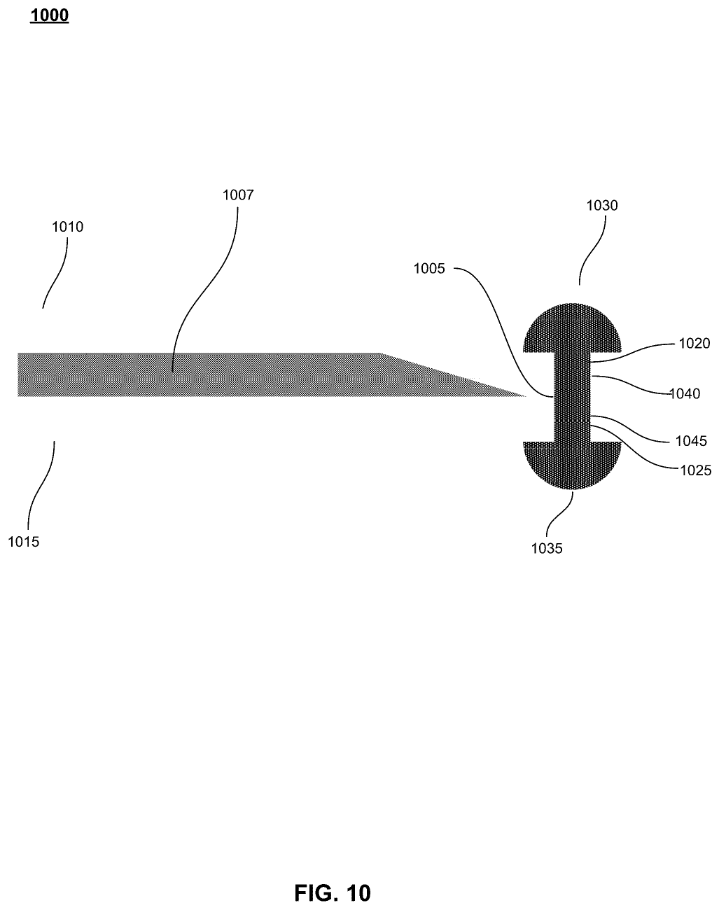

Although first component 110 may be illustrated and described with certain features with respect to FIG. 1, the features of and techniques applied to first comment 110 may also be applied to other embodiments of the first component, as described herein. For example, first component 210 (as discussed with respect to FIG. 2), first component 310 (as discussed with respect to FIG. 3), first component 410 (as discussed with respect to FIG. 4), first component 510a-d (as discussed with respect to FIG. 5), first component 610a-c (as discussed with respect to FIG. 6), first component 910 (as discussed with respect to FIG. 9), and first component 1010 (as discussed with respect to FIG. 10). Additionally, although second component 115 may be illustrated and described with certain features with respect to FIG. 1, the features of and techniques applied to second component 115 may also be applied to other embodiments of the second component, as described herein. For example, second component 215 (as discussed with respect to FIG. 2), second component 315 (as discussed with respect to FIG. 3), second component 415 (as discussed with respect to FIG. 4), second component 515a-d (as discussed with respect to FIG. 5), second component 615a-c (as discussed with respect to FIG. 6), second component 915 (as discussed with respect to FIG. 9), and second component 1015 (as discussed with respect to FIG. 10).

Although first bulge feature 130 and second bulge feature 135 may be illustrated and described with certain features with respect to FIG. 1, the features of and techniques applied to first and second bulge features 130, 135 may also be applied to other embodiments of first and second bulge features, as described herein. For example, first and second bulge feature 230, 235 (as discussed with respect to FIG. 2), first and second bulge feature 330, 335 (as discussed with respect to FIG. 3), first and second bulge feature 430, 435 (as discussed with respect to FIG. 4), first and second bulge feature 530a-c, 535a-d (as discussed with respect to FIG. 5), first and second bulge feature 630a-c, 635c (as discussed with respect to FIG. 6), first and second bulge feature 930, 935 (as discussed with respect to FIG. 9), and first and second bulge feature 1030, 1035 (as discussed with respect to FIG. 10).

Although adhesive 105 may be illustrated and described with certain features with respect to FIG. 1, the features of and techniques applied to adhesive 105 may also be applied to other embodiments of the adhesive, as described herein. For example, adhesive 205 (as discussed with respect to FIG. 2), adhesive 305 (as discussed with respect to FIG. 3), adhesive 405 (as discussed with respect to FIG. 4), adhesive 505a-d (as discussed with respect to FIG. 5), and adhesive 605a-c (as discussed with respect to FIG. 6), adhesive 905 (as discussed with respect to FIG. 9), and adhesive 1005 (as discussed with respect to FIG. 10).

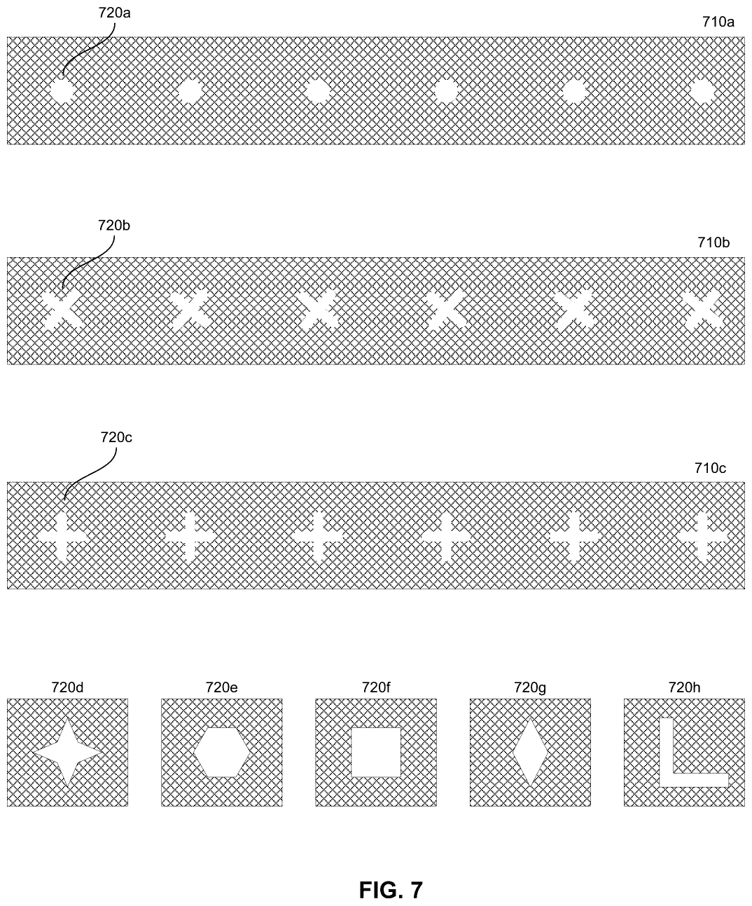

Although first escape hole 120 and second escape hole 125 may be illustrated and described with certain features with respect to FIG. 1, the features of and techniques applied to first and second escape holes 120, 125 may also be applied to other embodiments of the escape holes, as described herein. For example, first and second escape holes 220, 225 (as discussed with respect to FIG. 2), first and second escape holes 320, 325 (as discussed with respect to FIG. 3), first and second escape holes 720a-h, 725a-h (as discussed with respect to FIG. 7), first and second escape holes 920, 925 (as discussed with respect to FIG. 9), and first and second escape holes 1020, 1025 (as discussed with respect to FIG. 10).

In another example embodiment of the present disclosure and with reference to FIG. 2, an adhesion mold locking fastener 200 is implemented with the use of first mold 250 and second mold 255. As illustrated, first component 210 is adjacent to second component 215, having adhesive 205 distributed therebetween. First component 210 includes first escape hole 220, though which the first adhesive fastener shank 240 passes. Similarly, second component 215 includes second escape hole 225, though which second adhesive fastener shank 245 passes. The fastener includes first bulge feature 230 and second bulge feature 235 next to first component 210 and second component 215, respectively. First mold 250 includes first mold cavity 260. Similarly, second mold 255 includes second mold cavity 265. First mold 250 and second mold 255 may be constructed from any suitably rigid or semi-rigid material without departing from the contemplated embodiments.

In an example embodiment, first mold 250 is positioned such that first mold cavity 260 is adjacent to first escape hole 220 and second mold 255 is positioned such that second mold cavity 265 is adjacent to second escape hole 225. In an embodiment, adhesive 205 is disbursed between first component 210 and second component 215. When a force is applied to first component 210 in the direction of second component 215 (and an equal and opposite force is applied to second component 215), adhesive 205 flows between first component 210 and second component 215. Some of the flowing adhesive 205 flows though first escape hole 220 and second escape hole 225, which then passes into first mold cavity 260 and second mold cavity 265. When adhesive 205 is sufficiently set, first mold 250 and second mold 255 may be removed, thereby leaving first bulge feature 230 and second bulge feature 235. Such methodology is discussed in further detail herein, for example with respect to FIGS. 3A-3D. The profiles of first mold cavity 260 and second mold cavity 265 are configurable to form a desired first and second bulge feature shape. For example, if an oblate hemispheroidal shape is desired for first bulge feature 230, first mold cavity 260 is configured to have a profile of an oblate hemispheroid. In this way, mold cavities 260, 265 may be configured to achieve a desired bulge feature shape. Additionally, the profiles of first and second mold cavities 260, 265 need not be the same, similar, or complementary, according to various embodiments of the present disclosure.

Although first mold cavity 260 and second mold cavity 265 may be illustrated and described as having a relatively smooth, continuous surface, first mold cavity 260 and second mold cavity 265 may include additional features. For example, in some embodiments, first mold cavity 260 and second mold cavity 265 may optionally include one or more vent holes though which air escapes the mold cavity that would otherwise be trapped within the mold cavity while adhesive 205 fills the cavity (not illustrated). In some embodiments, compressed air (or other fluid) may be injected into first mold cavity 260 and second mold cavity 265, for example, via vent holes (as previously discussed) to assist in releasing adhesive 205. Although first mold 250 and second mold 255 may be illustrated and described with certain features with respect to FIG. 2, the features of and techniques applied to first and second mold 250, 255 may also be applied to other embodiments of molds, as described herein. For example, first and second molds 350, 355 (as discussed with respect to FIG. 3). Although first mold cavity 260 and second mold cavity 265 may be illustrated and described with certain features with respect to FIG. 2, the features of and techniques applied to first and second mold cavities 260, 265 may also be applied to other embodiments of mold cavities, as described herein. For example, first and second mold cavities 360, 365 (as discussed with respect to FIG. 3).

In some embodiments, the surface of first mold cavity 260 and second mold cavity 265 may be smooth. In other embodiments, the surface of first mold cavity 260 and second mold cavity 265 may be textured to allow adhesive 205, after having cured or hardened, to release from the surfaces of first mold cavity 260 and second mold cavity 265. In yet other embodiments, a liner or other mold release may be implemented on the surface of first mold cavity 260 and second mold cavity 265 to enable hardened/cured adhesive 205 to release from first mold 250 and second mold 255.

Although “curing” or “cure” may be used to describe the process by which adhesive 205 hardens, any number of descriptive terms may be used without departing from the contemplated embodiments. Other similar terms that may be used without departing from the contemplated embodiments include drying, hardening, vulcanizing, amalgamating, congealing, crystalizing, ossifying, setting, and solidifying. Such terms may be used to describe the process that adhesive 205 undergoes. For example, “curing” may refer to a chemical reaction (e.g., a polymerization reaction) that occurs during the application or use of the adhesive and may be the result of two or more chemical components reacting or cross-linking, resulting in a physical change from a liquid to a solid. “Curing” may also refer to drying, which includes the loss of liquid components of the adhesive and the evaporation of the carrier (i.e., water or solvent added to make the adhesive liquid), which results in a solid film.

In another example embodiment of the present disclosure and with reference to FIGS. 3A-3D, an adhesion mold locking fastener 300 is implemented to fasten first component 310 to second component 315. As illustrated in FIG. 3A, adhesive 305 is disbursed on second component 315. Although adhesive 305 may be illustrated and described as being initially disbursed on second component 315, adhesive 305 may be initially disbursed on second component 315, first component 310, first mold 350, and/or second mold 355, without departing from the contemplated embodiments. First mold 350 is positioned proximate to first component 310 such that first mold cavity 360 is aligned with first escape hole 320. Similarly, second mold 355 is positioned proximate to second component 315 such that second mold cavity 365 is aligned with second escape hole 325. Additionally, although adhesive 305 may be illustrated and described as being applied in discrete and separate portions, adhesive 305 may be applied in other ways without departing from the contemplated embodiments. For example, adhesive 305 may be applied as a single, continuous bead along one or more portions of first component 310 and/or second component 315. Moreover, multiple beads or portions of adhesive 305 may be applied to one or more portions of first component 310 and/or second component 315. In some embodiments, adhesive 305 may also be applied to first component 310 at the location of first escape hole 320. In other embodiments, adhesive 305 may be applied to second component 315 at the location of second escape hole 325.

As illustrated in FIG. 3B, first component 310 and 2nd component 315 are pressed together, thereby causing adhesive 305 to flow in the space between first component 310 and second component 315. As adhesive 305 continues to flow, some of it flows through first escape hole 320 and second escape hole 325, which ultimately leads to first mold cavity 360 and second mold cavity 365.

As illustrated in FIG. 3C, as adhesive flows through first escape hole 320 and second escape hole 325, adhesive 305 fills first mold cavity 360 and second mold cavity 365. Although first mold cavity 360 and second mold cavity 365 may be illustrated and described as having a relatively smooth, continuous surface, first mold cavity 360 and second mold cavity 365 may include additional features. For example, in some embodiments, first mold cavity 360 and second mold cavity 365 may optionally include one or more vent holes though which air escapes the mold cavity that would otherwise be trapped within the mold cavity while adhesive 305 fills the cavity. In some embodiments, compressed air (or other fluid) may be injected into first mold cavity 360 and second mold cavity 365, for example, via vent holes (as previously discussed) to assist in releasing adhesive 305.

In some embodiments, the surface of first mold cavity 360 and second mold cavity 365 may be smooth. In other embodiments, the surface of first mold cavity 360 and second mold cavity 365 may be textured to allow adhesive 305, after having cured or hardened, to release from the surfaces of first mold cavity 360 and second mold cavity 365. In yet other embodiments, a liner or other mold release may be implemented on the surface of first mold cavity 360 and second mold cavity 365 to enable hardened/cured adhesive 305 to release from first mold 350 and second mold 355.

As illustrated in FIG. 3D, first mold 350 and second mold 360 are removed. In some embodiments, first mold 350 and second mold 360 are removed when adhesive 305 is fully hardened or cured. In other embodiments, first mold 350 and second mold 360 are released prior to adhesive 305 fully curing or hardening. For example, first mold 350 and second mold 360 may be removed prior to adhesive 305 fully curing or hardening to allow first mold 350 and second mold 360 to easily release from adhesive 305.

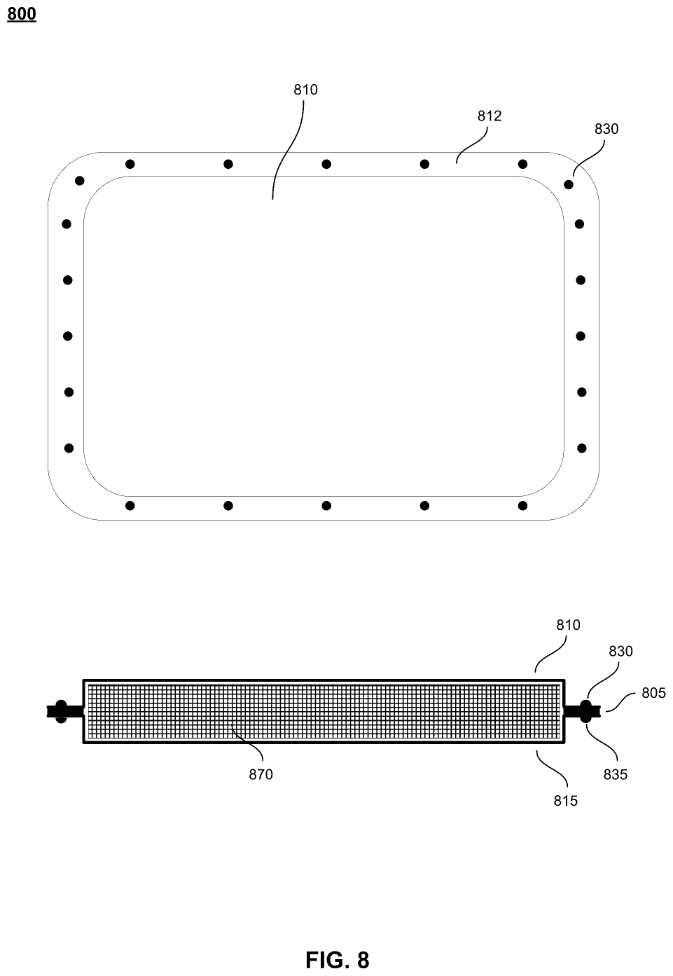

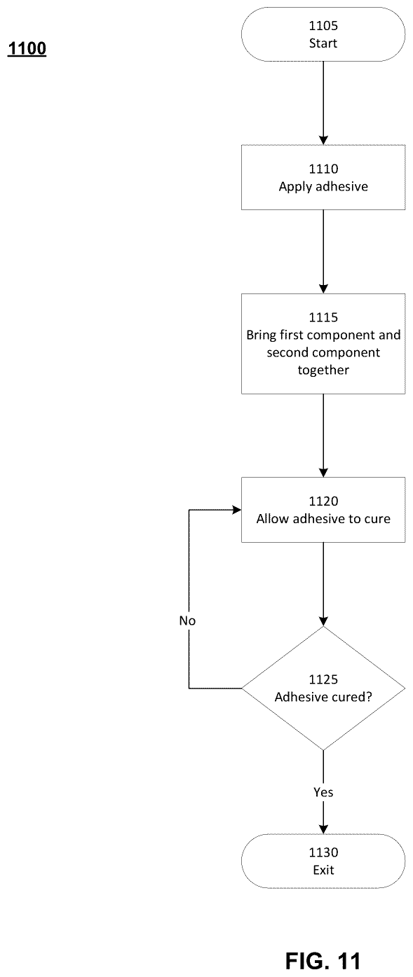

First bulge feature 330 is shaped by first mold cavity 360. Similarly, second bulge feature 335 is shaped by second mold cavity 365. In this way, the shape of first mold cavity 360 may be modified to achieve a desired shape of first bulge feature 330, as discussed herein, for example, as discussed with respect to FIG. 5. Additionally, the processes illustrated with respect to FIGS. 3A-3D are further described herein, for example, with respect to FIG. 8 and FIG. 11.

FIG. 4 Illustrates an exemplary adhesion mold locking fastener 400, according to various embodiments of the present disclosure. In an example embodiment, the techniques discussed herein may be applied to have multiple bulge features. As illustrated, first component 410 and second component 415 are fastened together using adhesive 405 with six first bulge features 430 and second bulge features 435, each spaced evenly apart at a distance d₂. In some embodiments, distance d₂ is approximately 50 mm to 150 mm. In other embodiments, distance d₂ is less than 50 mm. In other embodiments, distance d₂ is greater than 150 mm. Additionally, the first component 410 is spaced a distance d₁ from second component 415. In some embodiments, d₁ is 0.5 mm. However, in other embodiments, d₁ can be less than or greater than 0.5 mm without departing from the contemplated embodiments.

As illustrated, first component 410 and second component 415 are fastened together using adhesive 405 with multiple first bulge features 430 and second bulge features 435. Although six first bulge features 430 and six second bulge features 435 are illustrated and described, any number of first bulge features 430 and second bulge features 435 may be implemented without departing from the contemplated embodiments. Additionally, although consecutive first and second bulge features 430, 435 may be illustrated and described as being a uniform distance d apart, the distance between consecutive first and second bulge features 430, 435 may be any distance, be uniform, or not be uniform, without departing from the contemplated embodiments.

FIG. 5 Illustrates an exemplary adhesion mold locking fastener 500, according to various embodiments of the present disclosure. In an example, first and second bulge features may have different shapes without departing from the contemplated embodiments. For example, first bulge feature 530a and second bulge feature 535a may be embodied by a flat head shape with rounded sides (also sometimes referred to as a tinners head). In another example, first bulge feature 530b and second bulge feature 535b may be embodied by a rounded head shape (also sometimes referred to as a snap head, cup head, a truss head, or a button head). In another example, first bulge feature 530b and second bulge feature 535b may be embodied by an oblate hemispheroidal shape, i.e., a half sphere-like shape that is flattened at the pole and bulging at the equator.

In another example, first bulge feature 530c and second bulge feature 535c may be embodied by a flat head shape with straight sides (also sometime referred to as a flat head or a square head). In other examples, first and second bulge features may be a combination of those discussed herein. In such an example, first bulge feature 530d and second bulge feature 535d may be embodied by a combination of a flat head shape and a rounded head shape. Other example head shapes that may be implemented without departing from the contemplated embodiments include a pan head, a high button head, a steeple head, a conical head, a snap head, an ellipsoid head, a brazier head, a domed head, a mushroom head, and a universal head. In addition to the various shapes, one or more of first and second bulge features 530, 535 may also be countersunk and/or undercut (i.e., including an indentation or protrusion that helps prevent the fastener's removal from the escape holes and/or components).

FIG. 6 Illustrates an exemplary adhesion mold locking fastener 600, according to various embodiments of the present disclosure In an example embodiment, first and second bulge features 630, 635 may be asymmetrically arranged. In an example embodiment, first component 610a is fastened to second component 615a with adhesive 605a that additionally forms first bulge feature 630a. As illustrated, first bulge feature 630a does not have a corresponding second bulge feature. In another example embodiment, first component 610b is fastened to second component 615b with adhesive 605b that additionally forms three first bulge features 630b. As illustrated, first bulge features 630b do not have corresponding second bulge features. In another example embodiment, first component 610c is fastened to second component 615c with adhesive 605c that additionally forms first bulge features 630c and two second bulge features 635c. As illustrated, first bulge features 630c is not aligned with second bulge features 635c. Although a certain number of first and second bulge features are illustrated and described, any number of first bulge features and second bulge features may be used without departing from the contemplated embodiments. Additionally, first and second bulge features may be arranged symmetrically or asymmetrically without departing from the contemplated embodiments.

FIG. 7 Illustrates an exemplary adhesion mold locking fastener 700, according to various embodiments of the present disclosure. In an example embodiment, the escape holes of first component and second component may be embodied by any shape without departing from the contemplated embodiments. For example, escape hole 720a may be embodied by a round hole extending through component 710a. In another example, escape hole 720b is embodied by a cross-shaped hole extending through component 710b. In another example, escape hole 720c is embodied by a cross-shaped hole extending through component 710c. As compared to escape hole 720b, escape hole 720c is a similar shape but rotated approximately 45 degrees.

In some embodiments, the escape holes implemented throughout a first component and a second component are uniform. In such embodiments for example, escape holes 720a may be implemented in a first component (e.g., escape holes 120 of first component 110 as discussed with respect to FIG. 1) and in a second component (e.g., escape holes 125 of second component 115 as discussed with respect to FIG. 1). In other embodiments, escape holes implemented with a first component may be different than those implemented in a second component. In such embodiments for example, escape holes 720b may be implemented in a first component (e.g., escape holes 120 of first component 110 as discussed with respect to FIG. 1) and escape holes 720c may be implemented in a second component (e.g., escape holes 125 of second component 115 as discussed with respect to FIG. 1). In such embodiments, the escape holes are not uniform and provide additional fastening strength by virtue of in increased surface area, increased volume of fastener shank, and other factors.

Although various escape holes may be illustrated and described herein as being round or cross-shaped, various escape holes may be embodied by any shape without departing from the contemplated embodiments. For example, any of escape holes 720d-720h may be implemented instead of or in combination with other embodiments of escape holes discussed herein. Additionally, the escape holes implemented on a first component or a second component can vary without departing from the contemplated embodiments. In such embodiments for example, the escape holes implemented on a first component can be a combination of one or more of escape holes 720a-720h. Similarly, the escape holes implemented on a second component can be a combination of one or more of escape holes 720a-720h.

In another example embodiment of the present disclosure and with reference to FIG. 8, the adhesion mold locking fastener is implemented with a battery pack 800. As illustrated, first component 810 is embodied by the first half of a two-part casing that surrounds battery 870. Similarly, second component 815 is embodied by the second half of the two-part casing that surrounds battery 870. First component 810 further includes flange 812. As illustrated, multiple adhesion mold locking fasteners are implemented around the perimeter of first and second component 810 and 815 (e.g., via flange 812). For example, multiple adhesion mold locking fasteners may be implemented around a first perimeter of first component 810 and a second perimeter of second component 815. Adhesive 805 is located between the mating surfaces of first component 810 and second component 815. Although flange 812 is illustrated and described as completely circumscribing the first perimeter of first component 810, flange 812 may be implemented in other embodiments without departing from the contemplated embodiments. For example, flange 812 may partially circumscribe first perimeter of first component 810. In such an embodiment, flange 812 may extend along one side of first component 810. In another example, flange 812 may extend along two sides of first component 810. In such embodiments, the two sides may be continuous (e.g., the left and top side, as illustrated) or may not be continuous (e.g., the left and right side, as illustrated).

Although battery 870 may be illustrated and described as being relatively uniform, battery 870 may have other features without departing from the contemplated embodiments. For example, battery 870 may include multiple individual batteries or battery packs. In some embodiments, battery 870 may include other hardware or components. In such embodiments, battery 870 may include busbars, wiring, wiring components (e.g., plugs, harnesses), circuit boards, structural members (e.g., braces or flanges), and cooling components (e.g., heat exchangers, fans, fluids, etc.).

In another example embodiment of the present disclosure and with reference to FIG. 9, an adhesion mold locking fastener 900 is implemented to affix first component 910 to second component 915. First component 910 includes a shape that is different than second component 915, according to various embodiments of the present disclosure. As illustrated, one side of first component 910 (the right side, as illustrated in FIG. 9) curves towards and makes contact with second component 915. The fastener includes first bulge feature 930 and second bulge feature 935 next to first component 910 and second component 915, respectively. Adhesive 905 is disbursed between first component 910 and second component 915. First component 910 includes first escape hole 920, though which the first adhesive fastener shank 940 passes. Similarly, second component 915 includes second escape hole 925, though which second adhesive fastener shank 945 passes.

A feature of implementing the embodiment illustrated and described with respect to FIG. 9 is that the amount of the curve of first component 910 allows the distance between first component 910 and second component 915 at the location of escape holes 920, 925 to be predetermined, thus allowing a desired thickness of adhesive 905 to be present when adhesive 905 cures. For example, adhesive 905 may be applied to first component 910 and/or second component 915. When first component is brought together with second component 915, the right portions (as illustrated in FIG. 9) will come in contact with one another, thus preventing first component 910 from being brought closer to second component 915. In this way, the various portions of first component 910 and/or second component 915 may be configured to ensure a desired thickness of adhesive 905 once it has cured. Another feature of the embodiment illustrated in FIG. 9 is that such a configuration minimizes adhesive 905 from flowing out from in between first component 910 and second component 915.

Although the right side of first component 910 (as illustrated in FIG. 9) is illustrated and described as being curved (e.g., bent), any portion of either first component 910 and/or second component 915 may be curved or bent, whether uniform or irregular, without departing from the contemplated embodiments. Although the right portion of first component 910 (as illustrated in FIG. 9) may be illustrated and described as having a greater thickness, the features of such an embodiment may be achieved without implementing varying thicknesses. For example, the right portion (as illustrated in FIG. 9) may be bent or otherwise modified to achieve the same or similar functionality. In such an embodiment, first component 910 may be constructed from sheet metal and certain portions (e.g., the right portion, as illustrated in FIG. 9) may be bent to achieve the features discussed with respect to FIG. 9. Further, although adhesive 905 is illustrated and described as tapering and eventually terminating towards the right portions (as illustrated in FIG. 9) of first component 910 and second component 915, adhesive 905 may be present between first component 019 and second component 915 without departing from the contemplated embodiment.

In another example embodiment of the present disclosure and with reference to FIG. 10, an adhesion mold locking fastener 1000 is implemented to affix first component 1010 to second component 1015. First component 1010 includes a shape that is different than second component 1015, according to various embodiments of the present disclosure (as similarly illustrated and described with respect to FIG. 9 with varying scope). As illustrated, one side of first component 1010 (the right side, as illustrated in FIG. 10) is curved towards and contacts the corresponding portion of second component 1015. The fastener includes first bulge feature 1030 and second bulge feature 1035 next to first component 1010 and second component 1015, respectively. Adhesive 1005 is disbursed between first component 1010 and second component 1015. First component 1010 includes first escape hole 1040, though which the first adhesive fastener shank 1040 passes. Similarly, second component 1015 includes second escape hole 1025, though which second adhesive fastener shank 1045 passes. In some embodiments, sealant 1007 is applied between first component 1010 and second component 1015. In some embodiments, adhesive 1005 is different than sealant 1007. Such a configuration may be implemented where, for example, the characteristics of adhesive 1005 promote mechanical locking and the characteristics of sealant 1007 promotes sealing. In other embodiments, adhesive 1005 and sealant 1007 are the same material.

FIG. 11 illustrates an example process 1100 for fastening a first component and a second component together using the techniques of the present disclosure.

At 1105, process 1100 starts. In some embodiments, process 1100 receives input from, e.g., a user to start process 1100. In other embodiments, process 1100 is configured so that process 1100 begins when a catalyzing event is detected. For example, process 1100 detects that a first component and second component are located such that process 1100 may begin. In such an example, process 1100 may determine that the first component and second component are placed within, e.g., a jig or other manufacturing device configured to implement process 1100.

At 1110, adhesive is applied to the first component and/or the second component. In some embodiments, adhesive is applied by a user. In other embodiments, adhesive is applied by other manufacturing/assembly techniques, for example, robotically. In yet other embodiments, the first component and/or the second component already have adhesive applied. In such embodiments, 1110 is effectively undertaken during another manufacturing/assembly process.

At 1115, the first and second components are brought together. In some embodiments, the first and second components make contact at one or more points along first component and/or second component. In other embodiments, first component is brought to within a predetermined distance to the second component. In some embodiments, the first component and the second component are brought to approximately 0.5 mm of each other. In other embodiments, the first component and the second component are brought closer than or farther than 0.5 mm of each other. In some embodiments, a force is applied to the first component and/or the second component and, in some embodiments, maintained during various steps of process 1100. In some embodiments, for example those illustrated and discussed with respect to FIGS. 9 and 10, certain portions of first component and second component may be brought together such that they contact one another while maintaining a desired thickness of adhesive.

At 1120, the applied adhesive is allowed to cure. The time allotted to allow the adhesive to cure varies. In some embodiments, the curing time implemented varies with the type of adhesive. For example, RTV silicon adhesive may require approximately one minute to set, one hour to partially cure, and 24 hours to fully cure. Thus, in some embodiments where such RTV silicon is used, process 1100 may use approximately one minute to allow the adhesive to set before proceeding to 1125. In other embodiments where RTV silicon is used, process 1100 may use approximately one hour to allow the adhesive to partially cure before proceeding to 1125. In other embodiments where RTV silicon is used, process 1100 may use approximately 24 hours to allow the adhesive to fully cure before proceeding to 1125. The amount of curing (e.g., whether set, partially cured, or fully cured) depends on the specific implementation, the type of adhesive used (e.g., including those discussed with respect to FIG. 1), and other environmental factors. Example environmental factors that may impact the curing time allotted include ambient temperature, humidity, altitude, ambient pressure, and other factors may impact the required cure time. Additionally, process 1100 may use additives or other techniques to decrease the curing time. For example, process 1100 may optionally implement a vulcanizing or catalyzing agent that decreases the time require for a given adhesive to set, partially cure, or fully cure. In such embodiments, process 1100 adjusts the allotted cure time accordingly.

At 1125, process 1100 determines whether the adhesive is sufficiently cured. As discussed, the amount of curing depends on many factors. For example, process 1100 may be configured to only consider time. In such embodiments, process 1100 determines whether a sufficient amount of time has elapsed to allow the adhesive to sufficiently cure. In the event that process 1100 determines that a sufficient amount of time has not elapsed, process 1100 returns to 1120. In the event that process 1100 determines that a sufficient amount of time has elapsed, process 1100 continues to 1125, where process 1100 exits. In various embodiments, the characteristics of determining whether the adhesive has sufficiently cured depends on various factors. For example, process 1100 may determine that the adhesive is sufficiently cured when the adhesive is fully cured. In other example, process 1100 may determine that the adhesive is sufficiently cured when the adhesive is partially cured. In another example, process 1100 may determine that the adhesive is sufficiently cured when the adhesive is set. In another example, process 1100 may determine that the adhesive is sufficiently cured when subsequent manufacturing and/or assembly processes may be carried out on first component, second component, and/or another other component that may be impacted as a result of moving or jarring the first component and/or second component before the adhesive is sufficiently cured. In this way, process 1100 allows the adhesive to sufficiently cure so as to ensure proper functionality while minimizing the impact on other assembly and/or manufacturing processes that may be undertaken concurrently with undertaking the illustrated process 1100 for fastening a first component and a second component.

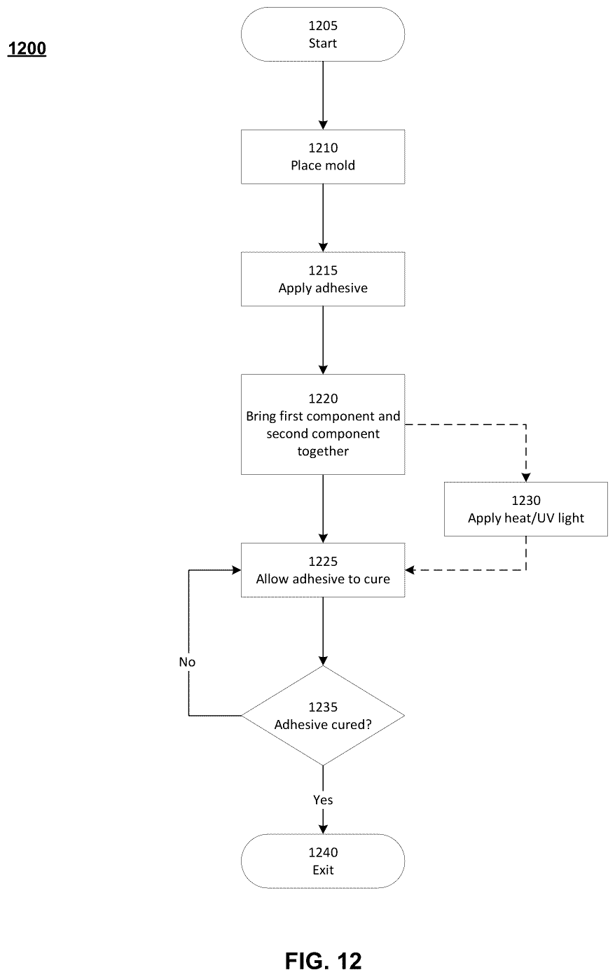

In some embodiments, process 1100 considers information from a sensor or other device that implicates the amount of curing achieved. For example, process 1100 may consider information from a temperature probe (e.g., a thermocouple) that indicates the temperature of the adhesive. In such an embodiment, process 1100 determines that the adhesive is sufficiently cured when the adhesive reaches a particular temperature. In other embodiments, process 1100 considers user input in determining whether the adhesive is sufficiently cured. In such an example, a user may inspect the first component, second component, first and second molds (in embodiments where they are implemented), and the adhesive to determine whether the adhesive is sufficiently cured. The process illustrated and described are discussed further herein, for example, with respect to FIGS. 3A-3D and FIG. 12.

FIG. 12 illustrates an example process 1200 for fastening a first component and a second component together using the techniques of the present disclosure.

At 1205, process 1200 starts. In some embodiments, process 1200 receives input from, e.g., a user to start process 1200. In other embodiments, process 1200 is configured so that process 1200 begins when a catalyzing event is detected. For example, process 1200 detects that a first component and second component are located such that process 1200 may begin. In such an example, process 1200 may determine that the first component and second component are placed within, e.g., a jig or other manufacturing device configured to implement process 1200.

At 1210, one or more molds are placed. In some embodiments, a first mold is placed proximate to the first component such that a first mold cavity aligns with a first escape hole of first component. In other embodiments, a second mold is placed proximate to the second component such that a second mold cavity aligns with a second escape hole of second component. In some embodiments, a single mold is implemented while in other embodiments, multiple molds are implemented.

At 1215, adhesive is applied to the first component and/or the second component. In some embodiments, adhesive is applied by a user. In other embodiments, adhesive is applied by other manufacturing/assembly techniques, for example, robotically. In yet other embodiments, the first component and/or the second component already have adhesive applied. In such embodiments, 1215 is effectively undertaken during another manufacturing/assembly process. In some embodiments, adhesive is also applied to the mold cavity. In such embodiments, adhesive is applied to a first mold cavity of a first mold. In other embodiments, adhesive is applied to a second mold cavity of a second mold.

At 1220, the first and second components are brought together. In some embodiments, the first and second components make contact at one or more points along first component and/or second component. In other embodiments, first component is brought to within a predetermined distance to the second component. In some embodiments, the first component and the second component are brought to approximately 0.5 mm of each other. In other embodiments, the first component and the second component are brought closer than, or farther than, 0.5 mm of each other. In some embodiments, a force is applied to the first component and/or the second component and, in some embodiments, maintained during various steps of process 1200. In some embodiments, the first and second components, along with the first and second molds, may be placed inside of a vacuum chamber and exposed to a vacuum. In such embodiments, the vacuum encourages bubbles to be expelled and better flow of the adhesive into the mold cavities. In some embodiments, for example those illustrated and discussed with respect to FIGS. 9 and 10, certain portions of first component and second component may be brought together such that they contact one another while maintaining a desired thickness of adhesive.

At 1225, the applied adhesive is allowed to cure. The time allotted to allow the adhesive to cure varies. In some embodiments, the curing time implemented varies with the type of adhesive. For example, RTV silicon adhesive may require approximately one minute to set, one hour to partially cure, and 24 hours to fully cure. Thus, in some embodiments where such RTV silicon is used, process 1200 may use approximately one minute to allow the adhesive to set before proceeding to 1235. In other embodiments where RTV silicon is used, process 1200 may use approximately one hour to allow the adhesive to partially cure before proceeding to 1235. In other embodiments where RTV silicon is used, process 1200 may use approximately 24 hours to allow the adhesive to fully cure before proceeding to 1235. The amount of curing (e.g., whether set, partially cured, or fully cured) depends on the specific implementation, the type of adhesive used, and other environmental factors. Example environmental factors that may impact the curing time allotted include ambient temperature, humidity, altitude, ambient pressure, and other factors that may impact the required cure time. Additionally, process 1200 may use additives or other techniques to decrease the curing time. For example, process 1200 may optionally implement a vulcanizing or catalyzing agent that decreases the time require for a given adhesive to set, partially cure, or fully cure. In such embodiments, process 1200 adjusts the allotted cure time accordingly.

At 1230, process 1200 may optionally apply heat to the first component, the second component, the first mold, and/or the second mold. In such embodiments, heat is applied to reduce the amount of time required to sufficiently cure the adhesive (for example, as discussed with respect to 1225 and 1230). In some embodiments, process 1200 may optionally apply UV light to accelerate the curing time of adhesive 1205.

At 1235, process 1200 determines whether the adhesive is sufficiently cured. As discussed, the amount of curing depends on many factors. For example, process 1200 may be configured to only consider time. In such embodiments, process 1200 determines whether a sufficient amount of time has elapsed to allow the adhesive to sufficiently cure. In various embodiments, the characteristics of determining whether the adhesive has sufficiently cured depends on various factors. For example, process 1200 may determine that the adhesive is sufficiently cured when the adhesive is fully cured. In other example, process 1200 may determine that the adhesive is sufficiently cured when the adhesive is partially cured. In another example, process 1200 may determine that the adhesive is sufficiently cured when the adhesive is set. In another example, process 1200 may determine that the adhesive is sufficiently cured when subsequent manufacturing and/or assembly processes may be carried out on first component, second component, and/or another other component that may be impacted as a result of moving or jarring the first component and/or second component before the adhesive is sufficiently cured. In this way, process 1200 allows the adhesive to sufficiently cure so as to ensure proper functionality while minimizing the impact on other assembly and/or manufacturing processes that may be undertaken concurrently with undertaking the illustrated process 1200 for fastening a first component and a second component. In the event that process 1200 determines that a sufficient amount of time has not elapsed, process 1200 returns to 1225. In the event that process 1200 determines that a sufficient amount of time has elapsed, process 1200 continues to 1240, where process 1200 exits.

In some embodiments, process 1200 considers information from a sensor or other device that implicates the amount of curing achieved. For example, process 1200 may consider information from a temperature probe (e.g., a thermocouple) that indicates the temperature of the adhesive. In such an embodiment, process 1200 determines that the adhesive is sufficiently cured when the adhesive reaches a particular temperature. In other embodiments, process 1200 considers user input in determining whether the adhesive is sufficiently cured. In such an example, a user may inspect the first component, second component, first and second molds (in embodiments where they are implemented), and the adhesive to determine whether the adhesive is sufficiently cured. The processes illustrated and described with respect to FIG. 12 are discussed further herein, for example, with respect to FIGS. 3A-3D and FIG. 11.

The processes discussed herein are intended to be illustrative and not limiting. For instance, the steps of the processes discussed herein may be omitted, modified, combined, and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

What is claimed is:

1. An adhesive fastener comprising:
a first bulge feature proximate to a first component comprising a first escape hole; and
a second bulge feature proximate to a second component comprising a second escape hole;
wherein the adhesive fastener extends from the first bulge feature through the first escape hole and the second escape hole to the second bulge feature.

2. The adhesive fastener of claim 1, wherein:
the first bulge feature corresponds to a first profile of a first mold applied to an exterior of the first component; and
the second bulge feature corresponds to a second profile of a second mold applied to the exterior of the second component.

3. The adhesive fastener of claim 1, wherein the first bulge feature and the second bulge feature are generally oblate hemispheroidal in shape.

4. The adhesive fastener of claim 1, wherein the first escape hole comprises a first generally circular shape and the second escape hole comprises a second generally circular shape.

5. The adhesive fastener of claim 1, wherein the first escape hole comprises a first shape and the second escape hole comprises a second shape similar to the first shape.

6. The adhesive fastener of claim 1, wherein the first escape hole comprises a first shape and the second escape hole comprises a second shape different than the first shape.

7. The adhesive fastener of claim 1, wherein:
the first escape hole comprises a first shape having a generally cross-shaped pattern; and
the second escape hole comprises a second shape having a generally cross-shaped pattern oriented approximately 45 degrees relative to the cross-shaped pattern of the first escape hole.

8. The adhesive fastener of claim 1, wherein a distance between the first component and the second component is between 0.25 mm and 0.75 mm.

9. The adhesive fastener of claim 1 further comprising a second adhesive bonding inner surfaces of the first component and the second component, wherein the first and second bulges are proximate to respective outer surfaces of the first and second components.

10. An apparatus comprising:
a first component comprising a first escape hole extending through the first component;
a second component comprising a second escape hole extending through the second component;
a first bulge feature proximate to the first escape hole and comprising an adhesive; and
a second bulge feature proximate to the second escape hole and comprising the adhesive;
wherein the adhesive extends from the first bulge feature though the first escape hole and the second escape hole to the second bulge feature.

11. The apparatus of claim 10, wherein the first escape hole is aligned with the second escape hole.

12. The apparatus of claim 10, wherein the first bulge feature corresponds to a first profile of a first mold applied to the exterior of the first component; and wherein the second bulge feature corresponds to a second profile of a second mold applied to the exterior of the second component.

13. The apparatus of claim 10, wherein the first escape hole comprises a first shape and the second escape hole comprises a second shape similar to the first shape.

14. The apparatus of claim 10, wherein a distance between the first component and the second component does not exceed 1 mm.

15. The apparatus of claim 10 further comprising a second adhesive applied bonding inner surfaces of the first component and the second component, wherein the first and second bulges are proximate to respective outer surfaces of the first and second components.

16. The apparatus of claim 10, wherein:
the first component is a first battery housing comprising a first flange;
the first escape hole extends through the first flange;
the second component is a second battery housing comprising a second flange; and
the second escape hole extends through the second flange.

17. The apparatus of claim 16, wherein:
the first flange at least partially circumscribes a first perimeter of the first battery housing; and
the second flange at least partially circumscribes a second perimeter of the second battery housing.

18. The apparatus of claim 16 further comprising a screw extending through the first escape hole and the second escape hole.

19. A method comprising:
applying an adhesive to one or both of a first surface of a first component comprising a first escape hole and a second surface of a second component comprising a second escape hole; and
bringing the first and second surfaces together to cause portions of the adhesive to pass through the first and second escape holes and form a first bulge feature and a second bulge feature proximate to the respective first and second escape holes.

20. The method of claim 19, further comprising:
applying a first mold proximate the first escape hole to receive and shape at least some of the adhesive that passes through the first escape hole to form the first bulge feature; and
applying a second mold proximate the second escape hole to receive and shape at least some of the adhesive that passes through the second escape hole to form the second bulge feature;
wherein the first mold and the second mold are at a temperature greater than ambient temperature when the adhesive is received and shaped.
